(19) United States
(12) Patent Application Publication
(10) Pub. No.: US 2010/0061020 A1
(43) Pub. Date: Mar. 11, 2010

(54) FLEXURE, HEAD SUSPENSION ASSEMBLY INCLUDING THE FLEXSURE, AND HARD DISK DRIVE INCLUDING THE HEAD SUSPENSION ASSEMBLY

(75) Inventors: Leonid Maslov, Yongin-si (KR); Cheol-soon Kim, Anyang-si (KR); Haeng-soo Lee, Suwon-si (KR)

Correspondence Address: VOLENTINE & WHITT PLLC, ONE FREEDOM SQUARE, 11951 FREEDOM DRIVE SUITE 1260, RESTON, VA, 20190, US

(73) Assignee: SAMSUNG ELECTRONICS CO., LTD., Suwon-si (KR)

(21) Appl. No.: 12/551,729

(22) Filed: Sep. 1, 2009

(30) Foreign Application Priority Data
Sep. 5, 2008 (KR) 10-2008-0087858

(51) Int. Cl. G11B 21/16

(52) U.S. Cl. 360/244.2; G9B/21.023

(57) ABSTRACT

A flexure suppresses the vibration of a slider bearing a magnetic read/write head. The flexure has a cross beam, a slider support that supports the slider and is in turn supported like a cantilever by the cross beam but so as to be elastic, a rear vibration absorber protruding from a free end of the slider support in a direction away from the cross beam, and a forward vibration absorber protruding from the cross beam in a direction opposite to that in which the rear vibration absorber protrudes from the free end of the slider support. In a head suspension assembly, an end of the flexure is fixed to a load beam. Also, the load beam is coupled to a base plate by, for example, a hinge. The head suspension assembly is carried by a swing arm in a hard disk drive. The swing arm is mounted to a base so as to be rotatable to position the magnetic read/write head over a data storage disk of the drive.

### BACKGROUND OF THE INVENTION

1. Field of the Invention

The present invention relates to a hard disk drive. More particularly, the present invention relates to a head suspension assembly of a hard disk drive which supports a read/write head of the drive.

2. Description of the Related Art

A hard disk drive (HDD) is an auxiliary memory used in computers, MP3 players, mobile phones, etc., for storing and retrieving data. To this end, an HDD generally includes a storage medium, namely a disk, and a magnetic head for recording data on the disk (writing) or reproducing data from the disk (reading). An HDD also includes a head suspension assembly which supports the magnetic head and which maintains the head over the recording surface of the disk as the head is writing data onto the disk or reading data from the disk.

FIG. 1 is a bottom view of a conventional head suspension assembly 10 of a hard disk drive.

Referring to FIG. 1, the head suspension assembly 10 includes a base plate 12 that is coupled to a swing arm (not shown), a hinge 14, a suspension 15 that is coupled to the base plate 12 through the hinge 14, and a slider 20 supported at a front end on the suspension 15. The suspension 15 includes a load beam 16 coupled to the hinge 14, and a flexure 17 having a first end fixed to a surface of the load beam 16 and a second end supporting the slider 20. A magnetic head 22 is mounted to the slider 20. When data is to be read from a disk or written onto a disk, the disk is rotated at a high speed, and the suspension 15 serves to keep the slider 20 and hence, the magnetic head 22, spaced a certain distance from the recording surface of the disk. The distance over which the slider 20 is spaced from the recording surface of the disk during such a “read/write” operation is referred to as the flying height.

Problems arise when the flying height is outside a certain range. For example, if the flying height is too great, i.e., if the slider 20 “flies” too high above the surface of the disk, the signals picked up by the magnetic head 22 during a read operation are too weak for the data to be discerned. Conversely, the signals generated by the magnetic head 22 during a write operation are too weak to record reproducible data on the disk. On the other hand, if the flying height is too small, i.e., if the slider 20 “flies” too close to the surface of the disk, head-disk interference (HDI) can occur. That is, the slider 20 and the recording surface of the disk can come into contact. In that case, data can be inadvertently erased from the disk or the surface of the disk may be damaged.

Furthermore, the slider 20 vibrates continuously due to the vibration of the suspension 15 during a normal operation of the HDD, i.e., even when the HDD is not receiving any external shocks. The normal vibration of the slider 20 while flying above the recording surface of the disk is referred to as slider flying height modulation.

Also, the memory capacity of disks of HDDs is becoming greater and the disks are becoming smaller to meet the demand for more compact electronic devices. As a result, the lower end of the specified range for the flying height of the sliders has been gradually decreasing. For example, the flying height in HDDs having 3.5 inch diameter disks is merely about 5 to 10 nm. Thus, the above-described problems, especially those as a result of HDI, are likely to occur in compact HDDs when the flying height modulation of the slider is high.

### SUMMARY OF THE INVENTION

An object of the present invention is to provide a flexure for supporting a slider bearing a magnetic read/write head, and which will suppress the vibration of the slider. Likewise, an object of the present invention is to provide a head suspension assembly that will maintain the flying height modulation of its slider within certain limits. Another object of the present invention is to provide a hard disk drive that is not likely to produce read/write errors and/or which is not prone to head disk interference.

According to an aspect of the present invention, there is provided a flexure including a slider support having a surface configured and dedicated to support a slider, a cross beam extending longitudinally in the widthwise direction of the flexure and supporting the slider support so as to be elastic, and vibration dampening means for suppressing the vibration of the slider support. The vibration dampening means is at least one elastic mass (vibration absorber) that is discrete from the slider support, considering the slider support to comprise that expanse of the flexure along which the slider is attached to the flexure.

According to another aspect of the present invention, there is provided a head suspension assembly including a slider, a magnetic read/write head integrated with the slider, a load beam, a base plate to which the load beam is coupled, and a vibration-dampening flexure as described above fixed to the load beam and to which the slider is attached.

The flexure may consist essentially of a single metal plate. In this case, the slider support, the cross beam and the vibration dampening means comprise unitary sections of the metal plate. Thus, each vibration absorber constituting the vibration dampening means may be constituted by a section of the metal plate. In particular, each vibration absorber may be in the form of one or more metal tabs. The tabs may have an inner segment, and an outer segment that extends around the inner segment as spaced therefrom. That is, each vibration absorber may have a plurality of absorption plates separated apart from each other. The tab(s) may also be covered with a viscous material.

Preferably, one vibration absorber is disposed to the rear of the slider support and another vibration absorber is disposed forward of the slider support. The vibration absorber(s) is/are symmetrical with respect to the longitudinal center line of the flexure to better suppress a rolling mode of vibrations in the slider support. As an example, the vibration absorber(s) is/are trapezoidal with the width thereof decreasing in a direction away from the slider support. Also, the vibration absorber or each vibration absorber may have an opening in its center.

According to another aspect of the present invention, there is provided a head suspension assembly in which the stiffness and coefficient of elasticity of the flexure are less than those of the load beam. These characteristics are provided so that the resonant frequencies of the flexure and the load beam will be different. As a result, there is less chance that vibrations in the load beam will induce vibrations in the flexure.

According to still another aspect of the present invention, there is provided a hard disk drive comprising a base, a motor mounted to the base, a disk coupled to the motor so as to be rotated by the motor, and an actuator having a swing arm that is mounted to the base so as to be rotatable relative to the base, and head suspension assembly including the above-described vibration-suppressing flexure.

### BRIEF DESCRIPTION OF THE DRAWINGS

These and other objects, features and advantages of the present invention will be more clearly understood from the following detailed description thereof taken in conjunction with the accompanying drawings in which:

FIG. 1 is a bottom view of a conventional head suspension assembly;

FIG. 2 is a perspective view of a hard disk drive according to the present invention;

FIG. 3 is a plan view of the head suspension assembly of the HDD of FIG. 2, according to the present invention;

FIG. 4 is a bottom view of the head suspension assembly of FIG. 3;

FIG. 5 is a plan view of the flexure of the head suspension assembly according to the present invention;

FIG. 6 is a graph showing vibration characteristics of a conventional head suspension assembly; and

FIG. 7 is a graph showing vibration characteristics of a head suspension assembly according to the present invention.

### DETAILED DESCRIPTION OF THE PREFERRED EMBODIMENTS

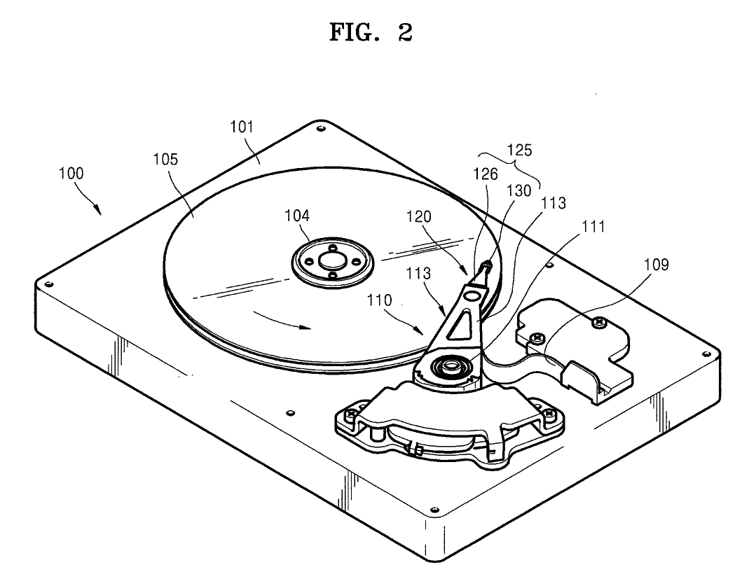

Referring first to FIG. 2, a hard disk drive 100 includes a housing formed of a base member 101 and a cover member (not shown) coupled thereto, and a spindle motor 104, a disk 105, and an actuator 110 disposed in the housing. The spindle motor 104 is fixed to the base member 101. The disk 105 is coupled to the spindle motor 104, and the spindle motor 104 is operable to rotate the disk 105 at a high speed in the direction of the arrow. Thus, airflow in the same direction as the rotation of the disk 105 is induced above a surface of the disk 105. The hard disk drive 100 also includes a main circuit board (not shown) disposed below the base member 101, and a flexible printed circuit (FPC) 109 that electrically connects the actuator 110 and the main circuit board.

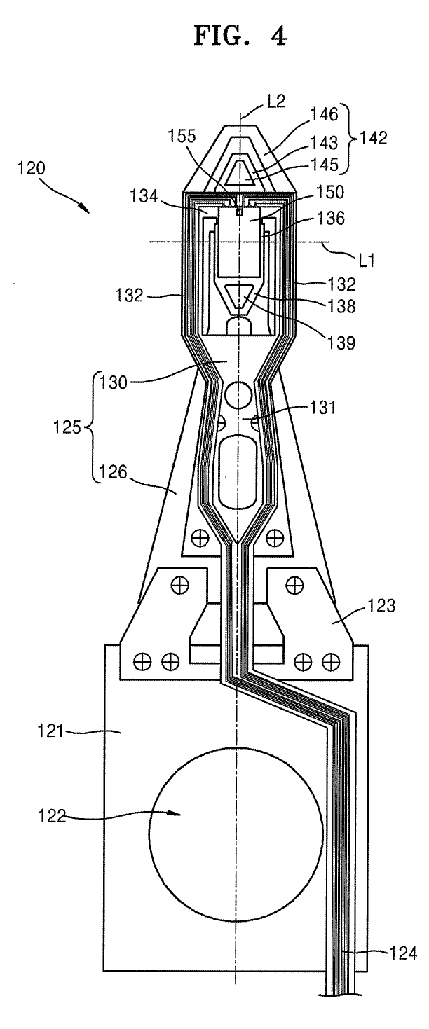

The actuator 110 includes a swing arm 113, a head suspension assembly 120 that is coupled to a front end of the swing arm 113, a pivot bearing 111 by which the swing arm 133 is mounted in the base member 101 so as to be rotatable, and a slider 150 supported by the head suspension assembly 120 as illustrated in FIG. 4. A magnetic head 155 for writing or reading data is mounted to the slider 150. The slider 150 is positioned over a desired track on the recording surface of the disk 105 by rotating the swing arm 113 of the actuator 110. To read data, the magnetic head 155 senses a variation in the magnetic field generated from a predetermined track on the surface of the disk 105 as the disk 105 is being rotated by the spindle motor 104. To write data, the magnetic head 155 receives a signal representative of the data and generates a magnetic field corresponding to the data. The magnetic field, in turn, magnetizes the surface of the disk 105 as the disk 105 is being rotated such that data is recorded along the track over which the head 155 is positioned.

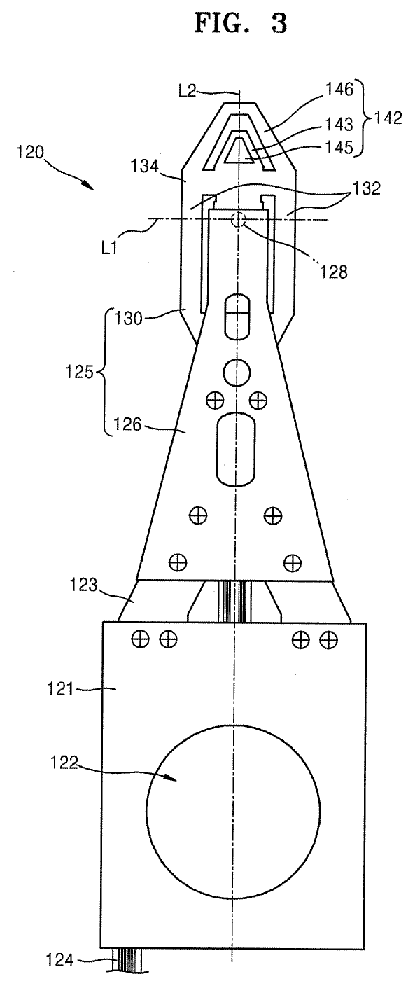

Referring to FIGS. 3 and 4, the head suspension assembly 120 includes a base plate 121 that is coupled to the swing arm 113, a hinge 123, and a suspension 125 coupled to the base plate 121 via the hinge 123. The slider 150 is supported at a front end of the suspension 125. The base plate 121 and a front end of the swing arm 113 are coupled to each other by a swage. In this respect, a swaging hole 122 by which the base plate 121 and swing arm 113 are fitted to one another is formed in the base plate 121.

The suspension 125 includes a load beam 126 coupled to the hinge 123, and a flexure 130 having a first end fixed on a surface of the load beam 125 facing the disk 105 and a second end supporting the slider 150. The flexibility of the suspension 125 creates a force that biases the slider 150 and hence, the magnetic head 155, toward the disk 105 during a read/write operation. Specifically, a lifting force is applied to the slider 150 as the airflow induced by the high speed rotation of the disk 105 passes between the surface of the disk 105 and the surface of the slider 150 facing the disk 105. As a result, the suspension 125 is flexed but urges the slider 150 towards the disk 105 in opposition to the lifting force. The slider 150 remains floating at a generally fixed height above the surface of the disk 105 when the lifting force is equal to the force by which the suspension 125 urges the slider 150 toward the disk 105. In this floating state, the magnetic head 155 mounted on the slider 150 writes data onto the disk 105 or reads data from the disk 105.

The head suspension assembly 120 also includes an interconnect 124 that electrically connects the magnetic head 155 and the FPC 109 (refer back to FIG. 2). The above-mentioned (read) signals received from the magnetic head 155 and (write) signals provided to the magnetic head 155 are transmitted to and from the main circuit board via the interconnect 124 and the FPC 109.

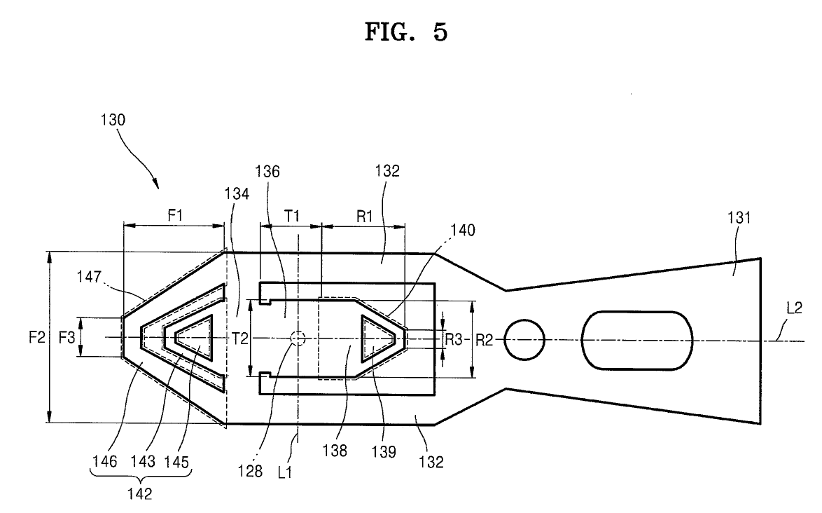

Referring to FIG. 5, the flexure 130 has a load beam coupling section 131 at a first end thereof, and a flexible or springy slider support (tongue) 136 at a second end thereof. The load beam coupling section 131 is that part of the flexure 130 at which the flexure 130 is fixed and is essentially immoveable relative to the load beam 126. On the other hand, the second end of the flexure 130 is a free end where the slider support 136 is free to move relative to the load beam 126. The slider 150 is supported by the slider support 136 over the entire length and breadth of the support. In this respect, the slider 150 (refer to FIG. 4) can be directly attached to the slider support 136 over its entire surface. Alternatively, a micro-actuator may be interposed between the slider support 136 and the slider 150. The micro-actuator is operative to adjust the position of the slider 150 by fine increments such that the magnetic head 155 will follow a track on the recording surface of the disk more precisely. Signals for driving the micro-actuator may be transmitted via the FPC 109 (refer to FIG. 2) and the interconnect 124 (refer to FIG. 4).

Referring to FIGS. 3-5, a dimple 128 protrudes from the load beam 126 into contact (point contact) with the slider support 136. Thus, the slider 150 can roll or pitch about the dimple 128 while floating above the disk 105. The rolling of the slider 150 refers to a minute amount of rotation of the slider 150 about a second virtual axis L2 which extends through the dimple 128 in the lengthwise direction of the flexure 130, and the pitching of the slider 150 refers to a minute amount of rotation of the slider 150 about a first virtual axis L1 which extends through the dimple 128 in the widthwise direction of the flexure 130 (perpendicular to the virtual axis L2).

In the case of a hard disk drive having 3.5 inch-diameter disks, the length T1 of the slider support 136 is about 0.5 mm, and the width T2 of the slider support 136 is about 0.7 mm. The slider support 136 is supported as a cantilever by a cross beam 134, namely a portion of the flexure 130 which extends in the same direction as the first virtual axis L1 (the widthwise direction of the flexure 130). Thus, the slider support 136 is supported by the cross beam 134 so as to be elastic. The ends of the cross beam 134 are connected to the load beam coupling section 131 of the flexure 130 via a pair of outriggers 132.

The flexure 130 also includes a rear vibration absorber 138 protruding from the slider support 136 toward the swing arm 113 of the actuator 110 (refer back to FIG. 2) and a forward vibration absorber 142 protruding from the cross beam 134 in a direction opposite to that in which the rear vibration absorber 138 protrudes from the slider support 136. The vibration absorbers 138, 142 are in the form of metal tabs. The rear vibration absorber 138 and the forward vibration absorber 142 are spaced from each other with respect to the dimple 128. That is, the rear vibration absorber 138 and the forward vibration absorber 142 are masses that can be vibrated at both sides of the slider support 136 supporting the slider 150. Therefore, vibration of the slider support 136 with respect to the first virtual axis L1 (and hence, vibration of the slider 150 that is supported by the slider support 136) can be reduced.

Also, the rear vibration absorber 138 and the forward vibration absorber 142 are each symmetrical with respect to the second virtual axis L2 (corresponding to the center line of the suspension assembly 120). Therefore, the rear vibration absorber 138 and the forward vibration absorber 142 constitute masses that can vibrate with respect to the second virtual axis L2. Thus, vibration of the slider support 136 with respect to the center line of the suspension assembly 120 (and hence, vibration of the slider 150 that is supported by the slider support 136) can be reduced.

The rear vibration absorber 138 and the forward vibration absorber 142 may be covered with viscous materials 140 and 147. The viscous materials 140 and 147 serve to attenuate vibrations. The viscous materials 140 and 147 may be films of polymer resin attached to or coatings of polymer material deposited (and then hardened) on the rear vibration absorber 138 and the forward vibration absorber 142. Also, the viscous materials 140 and 147 may be cover one surface or both surfaces of each of the rear vibration absorber 138 and the forward vibration absorber 142.

The rear vibration absorber 138 is trapezoidal, tapers in a direction away from the slider support 136, and has an opening 139 in its center. Similarly, the forward vibration absorber 142 is trapezoidal, tapers in a direction away from the slider support 136 and the cross beam 134, and has an opening 145 in its center. Furthermore, the forward vibration absorber 142 includes a first vibration absorption plate 143 at an inner portion thereof, and a second vibration absorption plate 146 that is spaced a predetermined distance from and surrounds the first vibration absorption plate 143. The opening 145 extends through a central portion of the first vibration absorption plate 143. The rear vibration absorber 138 may also include a plurality of vibration absorption plates that are spaced from each other.

However, the above-described shapes of the rear vibration absorber 138 and the forward vibration absorber 142 are exemplary only. That is, the rear vibration absorber 138 and the forward vibration absorber 142 may have shapes different from those illustrated in the figures. For example, the rear vibration absorber 138 and the forward vibration absorber 142 may be rectangular or parabolic. Also, the openings 139 and 145 in the rear and forward vibration absorbers 138 and 142 are not required.

Moreover, in the case of a hard disk drive having 3.5 inch-diameter disks, the length R1 of the rear vibration absorber 138 is about 1.3 mm, the maximal width R2 of the rear vibration absorber 138 (where the absorber 138 is connected to the slider support 136) is about 0.7 mm, and the minimal width R3 of the rear vibration absorber 138 (at the end of the rear vibration absorber 138 remote from the slider support 136) is about 0.16 mm. Also, the length F1 of the forward vibration absorber 142 is about 1.3 mm, the maximal width F2 of the forward vibration absorber 142 (where the forward vibration absorber 142 is connected to the cross beam 134) is about 1.5 mm, and the minimal width F3 of the forward vibration absorber 142 (at the end of the forward vibration absorber 142 remote from the cross beam 134) is about 0.4 mm.

A flexure 130 as described above may be formed by cutting or punching a metal plate. Also, according to an aspect of the present invention, the stiffness and coefficient of elasticity of the flexure 130 are smaller than those of the load beam 126, respectively. Accordingly, the flexure 130 and the load beam 126 have different resonant frequencies. In fact, the flexure 130 and the load beam 126 are designed such that the differences between their respective stiffnesses and coefficients of elasticity are responsible for resonant frequencies that are as different as possible. The greater the difference between the resonant frequencies of the flexure 130 and the load beam 126, the smaller is the chance that vibrations in the load beam 126 will induce vibrations in the flexure 130. Thus, the head suspension assembly 120 has excellent characteristics associated with the slider flying height modulation.

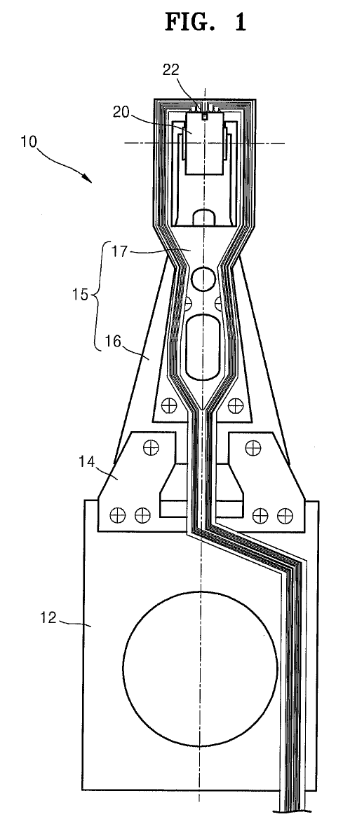

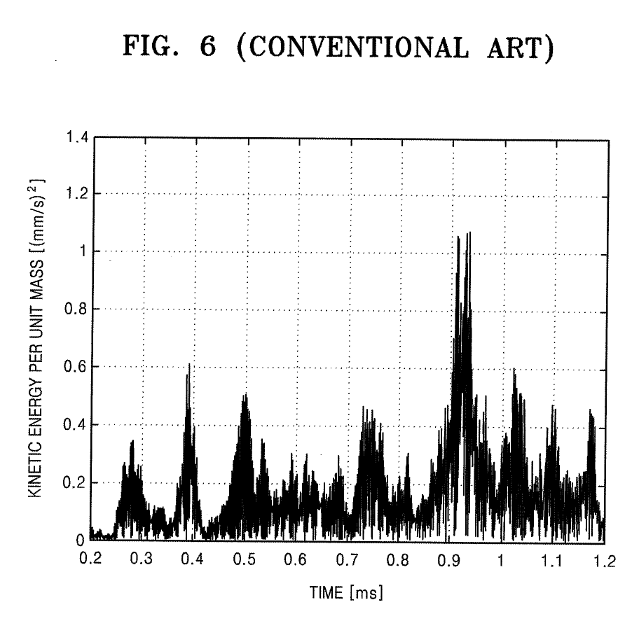

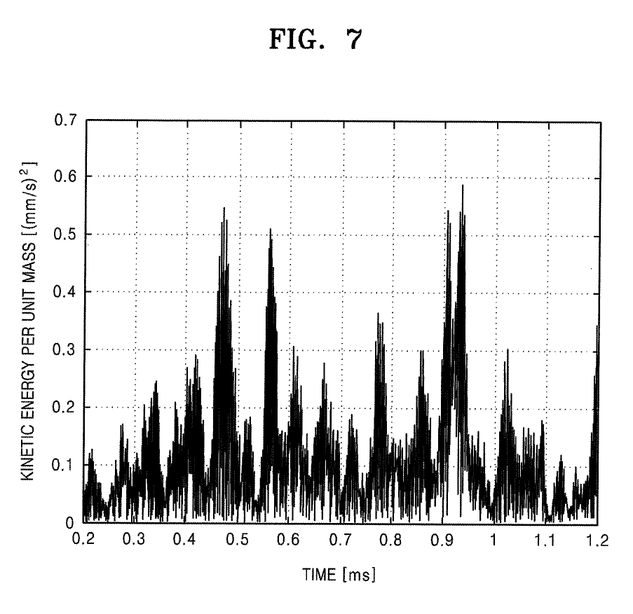

The inventors have through computer simulations qualified slider flying height modulation characteristics of a hard disk drive having a conventional head suspension assembly as illustrated in FIG. 1, and slider flying height modulation characteristics of a hard disk drive having a head suspension assembly according to the present invention as illustrated in FIG. 4. These simulations were conducted for hard disk drives having 3.5 inch diameter disks. The results of these simulations are shown in FIGS. 6 and 7. FIG. 6 is a graph showing vibration characteristics of the slider during the operation of a conventional hard disk drive having a head suspension assembly 10 of the type shown in FIG. 1, and FIG. 7 is a graph showing vibration characteristics of the slider during the operation of a hard disk drive according to the present invention having a head suspension assembly 120 of the type shown in FIGS. 3-5. The vertical axes of FIGS. 6 and 7 denote kinetic energy per unit mass of the slider, which is proportional to the amplitude of the vibrations of the slider.

Referring to FIG. 6, in the case of the conventional hard disk drive, the kinetic energy per unit mass of the slider exceeded 1.0 (mm/s)², the kinetic energy on average per unit mass was 0.156 (mm/s)², and a standard deviation was 0.148 (mm/s)². Referring to FIG. 7, in the case of the hard disk drive according to the present invention, the kinetic energy per unit mass of the slider never exceeded 0.6 (mm/s)², the kinetic energy on average per unit mass was 0.103 (mm/s)², and the standard deviation was 0.093 (mm/s)². As is thus apparent from the results of the simulations shown in FIGS. 6 and 7, a head suspension assembly according to the present invention has better vibration characteristics than the conventional head suspension assembly.

The inventors have also compared rolling mode vibration characteristics of the slider of the conventional hard disk drive and those of the slider of the hard disk drive according to the present invention. For the purpose of describing the results of this comparison, the end of the slider nearest to the center of the disk will be referred to as the inner tip of the slider, the end of the slider furthest from the center of the disk will be referred to as the outer tip of the slider, and a portion of the slider midway between the inner tip and the outer tip will be referred to as the center of the slider.

The average amplitude of the vibrations at the inner tip of the slider of the conventional hard disk drive was 0.309 nm and the average vibratory speed thereof was 295.0 μm/s. Also, the average amplitude of the vibrations at the outer tip of the slider of the conventional hard disk drive was 0.318 nm, and the average vibratory speed thereof was 309.4 μm/s. The average amplitude of the vibrations at the center of the slider of the conventional hard disk drive was 0.168 nm, and the average vibratory speed was 182.5 μm/s.

In contrast, regarding the hard disk drive 100 according to the present invention, the average amplitude of the vibrations at the inner tip of the slider was 0.253 nm, and the average vibratory speed thereof was 241.4 μm/s. The average amplitude of the vibrations at the outer tip of the slider was 0.262 nm, and the average vibratory speed thereof was 257.0 μm/s. The average amplitude of the vibrations at the center of the slider was 0.127 nm, and the average vibratory speed thereof was 138.6 μm/s. Thus, a slider of a hard disk drive according to the present invention has better rolling mode vibration characteristics than a slider of a conventional hard disk drive.

According to the present invention as described above, a flexure that supports a slider in an actuator of a hard disk drive includes at least one vibration absorber to minimize vibrations of the slider during the operation of the hard disk drive. Thus, a hard disk drive according to the present invention is less likely to create read/write errors and is less prone to head disk interference (HDI) which can damage the magnetic head and/or the disk of the drive.

Finally, although the present invention has been shown and described in connection with the preferred embodiments thereof, it is to be understood that the scope of the present invention is not so limited. On the contrary, various modifications of and changes to the preferred embodiments will be apparent to those of ordinary skill in the art. Thus, changes to and modifications of the preferred embodiments may fall within the true spirit and scope of the invention as defined by the appended claims.

What is claimed is:

1. A flexure for use in supporting a slider of a hard disk drive, the flexure comprising:
a slider support having a surface dedicated to support the slider;
a cross beam extending longitudinally in the widthwise direction of the flexure and supporting the slider support so as to be elastic; and
vibration dampening means for dampening vibrations in the flexure to suppress the vibration of the slider support.

2. The flexure of claim 1, comprising a metal plate, and wherein the slider support, the cross beam and the vibration dampening means comprise unitary sections of the metal plate.

3. The flexure of claim 1, wherein the vibration dampening means comprises at least one vibration absorber constituted by an elastic mass.

4. The flexure of claim 3, wherein the at least one vibration absorber comprises a rear vibration absorber protruding from the slider support in a direction away from the cross beam.

5. The flexure of claim 3, wherein the at least one vibration absorber comprises a forward vibration absorber protruding from the cross beam in a direction away from the slider support.

6. The flexure of claim 3, wherein the at least one vibration absorber comprises a vibration absorber that is symmetrical with respect to the longitudinal center line of the flexure.

7. The flexure of claim 1, wherein the vibration dampening means comprises a plate covered with viscous material.

8. The flexure of claim 3, wherein the at least one vibration absorber comprises a vibration absorber that has an opening extending through its center.

9. The flexure of claim 3, wherein the at least one vibration absorber comprises a plate including an inner segment, and an outer segment that extends around the inner segment as spaced therefrom.

10. The flexure of claim 1, comprising a metal plate, and wherein the cross beam and slider support comprise sections of the metal plate, and the vibration dampening means comprises a rear vibration absorber constituted by a section of the metal plate protruding from the slider support in a direction away from the cross beam, and a forward vibration absorber constituted by another section of the metal plate protruding from the cross beam in a direction away from the slider support.

11. A head suspension assembly comprising:
a slider, and a magnetic read/write head integrated with the slider;
a load beam
a base plate to which the load beam is coupled; and
a flexure to which the slider is fixed, the flexure having a first end at which the flexure is fixed to the load beam, a slider support having a surface over which the slider is supported, a cross beam extending longitudinally in the widthwise direction of the flexure and supporting the slider support so as to be elastic, and vibration dampening means for dampening vibrations in the flexure to suppress the vibration of the slider.

12. The head suspension assembly of claim 11, wherein the flexure comprises a metal plate, and the slider support, the cross beam and the vibration dampening means of the flexure comprise unitary sections of the metal plate.

13. The head suspension assembly of claim 11, wherein the vibration dampening means of the flexure comprises at least one vibration absorber constituted by an elastic mass.

14. The head suspension assembly of claim 13, wherein the at least one vibration absorber comprises a rear vibration absorber protruding from the slider support in a direction towards the load beam.

15. The head suspension assembly of claim 13, wherein the at least one vibration absorber comprises a forward vibration absorber protruding from the cross beam in a direction away from the slider support.

16. The head suspension assembly of claim 13, wherein the at least one vibration absorber is symmetrical with respect to the longitudinal center line of the flexure.

17. The head suspension assembly of claim 16, wherein the load beam has a dimple that contacts the slider support of the flexure at a point along the longitudinal center line of the flexure.

18. The head suspension assembly of claim 11, wherein the flexure comprises a metal plate, the cross beam and slider support comprise sections of the metal plate, and the vibration dampening means comprises a rear vibration absorber constituted by a section of the metal plate protruding from the slider support in a direction away from the cross beam, and a forward vibration absorber constituted by another section of the metal plate protruding from the cross beam in a direction away from the slider support

19. The head suspension assembly of claim 11, wherein the stiffness and coefficient of elasticity of the flexure are less than the stiffness and coefficient of elasticity of the load beam, respectively.

20. A hard disk drive comprising:
a base;
a motor mounted to the base;
a disk coupled to the motor so as to be rotated by the motor; and
an actuator having a swing arm that is mounted to the base so as to be rotatable relative to the base, and a head suspension assembly connected to the swing arm,
the head suspension assembly comprising a slider, a magnetic read/write head integrated with the slider, a load beam, and a flexure to which the slider is fixed,
wherein the flexure has a first end at which the flexure is fixed to the load beam, a slider support having a surface over which the slider is supported, a cross beam extending longitudinally in the widthwise direction of the flexure and supporting the slider support so as to be elastic, and vibration dampening for dampening vibrations in the flexure to suppress the vibration of the slider.
